(19) United States
(12) Patent Application Publication
(10) Pub. No.: US 2023/0223712 A1
(43) Pub. Date: Jul. 13, 2023

(54) CONTACT ELEMENT FOR CONTACTING ELECTROTECHNICAL COMPONENTS AND ELECTROTECHNICAL COMPONENT

(71) Applicant: Phoenix Contact GmbH & Co. KG, Blomberg (DE)

(72) Inventor: Elmar Schaper, Luegde (DE)

(21) Appl. No.: 17/785,439

(22) PCT Filed: Dec. 10, 2020
(86) PCT No.: PCT/EP2020/085457

§ 371 Date: Mar. 9, 2023

(30) Foreign Application Priority Data
Dec. 16, 2019 (DE) 10 2019 134 584.7

(51) Int. Cl. H01R 9/26; H01R 13/11

(52) U.S. Cl. CPC H01R 9/2675; H01R 13/112; H01R 43/16

(57) ABSTRACT

A contact element for contacting electrotechnical components includes: a leadframe part made of an electrically conductive material, having a recess in a contact tab. The contact tab is formed to be curved at at least one location such that a curving line, along which a curvature is present, extends between a beginning and an end of the recess and runs transversely through the contact tab in a straight line.

### CROSS-REFERENCE TO PRIOR APPLICATIONS

This application is a U.S. National Phase application under 35 U.S.C. § 371 of International Application No. PCT/EP2020/085457, filed on Dec. 10, 2020, and claims benefit to German Patent Application No. DE 10 2019 134 584.7, filed on Dec. 16, 2019. The International Application was published in German on Jun. 24, 2021 as WO/2021/122276 under PCT Article 21(2).

### FIELD

The invention relates to a contact element, which serves the purpose of contacting electrotechnical components. The proposal furthermore relates to an electrotechnical component, which has at least one contact element according to the invention.

### BACKGROUND

In the case of industrial mass-produced subassemblies, in which not a large number of electrotechnical component parts are used, but a plurality of electrical connections is necessary, a leadframe or punched lattice part is often used. In the raw state, this leadframe part is typically a band material made of metal, which is then transferred into the necessary end state by means of various punches, bends, and nesting. A female terminal, which is designed for the assembly on mounting rails, is mentioned as an example for such a mass-produced component part. In many cases, such female terminals are used in the industrial automation or generally in the machine, plant, and process control. Electrotechnical components can be plugged into the female terminal. For this purpose, a corresponding slot is provided in the female terminal. The female terminal also serves the purpose of receiving an electromagnetic switching element, e.g., in the form of a relay or contactor.

Insulation displacement techniques are common when contacting wired components. This takes place in such a way that small connecting legs are pressed into a V section by means of an automated process. FIG. 1a shows the shape of the leadframe part, into which it is brought by means of punching. The V-shaped notch in the contact tab is clearly visible. However, this leadframe part still has a relatively long expansion in the vertical direction. The advantage of this form of contacting small wired legs is also that there is a certain flexibility in response to movements of the components during plug-in caused by twists or rotations, etc.

Due to more and more steps towards the miniaturization, it is no longer readily possible nowadays, however, to realize such large contact elements for contacting component parts comprising small wired legs.

For example, a demand on the development is to realize an extremely small construction of a relay socket of approx. 3 mm. This means that there are extreme demands with regard to the mechanical stress on the electrotechnical components caused by bending and twisting of the component (relay socket) during the assembly. During operation, further length changes on the metal are to be expected due to temperature fluctuations and mechanical stresses caused by vibration and shock/impact.

### SUMMARY

In an embodiment, the present invention provides a contact element for contacting electrotechnical components, comprising: a leadframe part comprising an electrically conductive material, having a recess in a contact tab, wherein the contact tab is formed to be curved at at least one location such that a curving line, along which a curvature is present, extends between a beginning and an end of the recess and runs transversely through the contact tab in a straight line.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1a-1d show several views of a first example of the shaping of a contact element comprising a cutting-spring assembly comprising a deflection according to the prior art;

FIGS. 2a-2d show several views of the first example of the shaping of a contact element comprising a cutting-spring assembly, but with a special deflection position according to the invention;

FIGS. 3a-3d show several views of a second example of the shaping of a contact element and deflection of a contact element comprising a snap-in point and special deflection position;

FIGS. 4a-4d show several views of a third example of the shaping of a contact element with a special design of the snap-in point and special deflection position;

FIG. 5 show a more in-depth illustration of the first exemplary embodiment of the shaping of a contact element comprising a cutting-spring assembly and the special deflection position; and

FIG. 6 shows a sectional illustration through a female terminal comprising an assembly of the contact elements according to the invention.

### DETAILED DESCRIPTION

In an embodiment, the present invention provides a solution for how a leadframe part can be designed, which meets the required miniaturization demands.

In one aspect, the invention relates to a contact element, which serves the purpose of contacting electrotechnical components, wherein the contact element is formed of a leadframe part of electrically conductive material and has a recess in a contact tab. In a special configuration, the contact tab is curved (bent) at at least one location, wherein the curving (bending) line of the contact tab, along which a curvature (or bending) is present (or takes place), extends between beginning and end of the recess, and runs in particular transversely through the contact tab in a straight line. Due to the curvature at this location, it is possible to design the component to be significantly narrower. At the same time, the flexibility, which is necessary for the arising mechanical stresses during assembly or during operation, is maintained. The leadframe part typically consists of metal because metal is particularly suitable for the punches, bends, and curvings, and, depending on the metal, can also be designed to be highly electrically conductive. It is pointed out here that the mentioned limit at the end of the recess is to be included in the scope of protection. The curving (or bending) could in particular be present (or take place) along a curving (bending) line at the end of the recess on the side of the component interior.

The recess can be made by punching the contact tab. The design of the recess will take place so that it is formed, starting at an outer, free edge (beginning) of the contact tab, in particular in the direction of the opposite edge (end) of the contact element. With this, a conductor can then be clamped into the recess.

In one variation, the recess can be shaped in the manner of a motion guide, which line course extends between beginning and end of the recess and follows a curved or bent (or angled) line course at least in some sections. However, the line course can also be a guide formed in the manner of a wavy line with one or a plurality of deflections.

In another variation, the recess is formed so that it tapers. The V-shaped design of the recess is particularly suitable for this purpose. It is mentioned, however, that the recess can extend along a line, which is formed differently, in particular bent or angled, and tapers in the direction of the “component interior”.

This form of the recess is advantageous for the realization of a cutting and spring region. When being pressed in, the wire is cut slightly and is thus held better in the recess. This applies in particular during accelerations in the longitudinal direction of the wire. The contact tab comprising a recess can be resilient particularly well in all three spatial directions in the case of the construction with the special angulation.

In a preferred variation, the recess is formed in a slit-shaped manner with parallel lateral lines, wherein the recess in the angled upper part of the contact tab is formed in such a way at one location that it has a snap-in point. The design of the edge of the recess to the interior of the contact tab can be varied. Production-related aspects can be the deciding factor here for which design is preferred.

In the case of one variation, the recess of the contact element is designed in a rectangular shape, wherein the edge is realized with a straight line, which runs at right angles to the lateral lines. Other variations relate to a rounded edge or an obliquely running edge between the lateral lines.

With this, a variation can then also be realized, in the case of which the recess of the contact element is designed in a rectangular shape in a lower part, wherein the recess is formed in such a way at one location that it has a snap-in point in the angled upper part of the contact tab. The cross-section of the rectangle is dimensioned so that with its diameter, the wire does not fit entirely into the recess. Instead, provision is made at the upper end of the recess for a snap-in point, which is dimensioned so that with its dimension, the wire fits in there. In order to get the wire to this position, a certain pressure has to thus be exerted during the plug-in. The recess in the contact tab ensured that the two legs of the contact tab can be bent apart easily and then spring back into the original position again. The wire is held securely at the snap-in point. When the snap-in point diameter is slightly smaller than the wire diameter, the wire is clamped when it is plugged in, and it is held more securely.

In an expansion of this embodiment, the contact element is designed so that the recess has a rectangular shape in the lower part and runs obliquely in the angled upper part. The rectangular part of the recess can be slightly offset from the center to the left or the right thereby. The bevel of the angled part ensures that the wire glides along the bevel into the middle position when being pressed in.

An advantageous measure is also that the obliquely running recess runs straight on one side of the upper end, and, on the other side of the upper end, ends in a configuration, which protrudes into the recess, and which serves as barbed hook for the connecting wire of the electronic component, which is pushed into the recess. When pushing the conductor into the fork, both legs are pushed to the outside. The end position of the conductor is reached when the conductor abuts on the stop bevel and the barbed hook has sprung back freely again. The barbed hook ensures a firm hold in response to electrical and mechanical stress.

In the case of a more general variation, the recess extends along a straight, bent, or angled line on one side of the upper end, and, on the other side of the upper end, ends in a configuration, which protrudes into the recess, and which serves as barbed hook for the connecting wire of the electrotechnical component pushed into the recess and counters a fall-out of the pushed-in connecting wire.

A preferred form of the configuration is thereby that the configuration protruding into the recess is formed convexly. The connecting wire can thus glide easily into a chamfer and can then push apart both legs simultaneously when being pressed in, until it arrives at the bevel. When it is then pressed a little further, it will glide along the bevel until the barbed hook is passed and springs back. When the pressing force decreases, the leg with the barbed hook will push the connecting wire back to the starting point of the bevel. The connecting wire is held there.

To even further improve the hold here, it is advantageous when the connecting wire of the component is also provided with a bead. The notched contact tab snaps into the bead and the connecting wire is held at the longitudinal position by means of the bead and can thus not slip in the longitudinal direction.

In another form, the invention relates to an electrotechnical component part, which has at least one contact element according to the invention. An electrotechnical component part is mentioned as example, which is configured as female terminal, which is designed for the mounting rail assembly, and which has a slot for receiving a passive or active component, such as resistor, diode, capacitor, transistor, thyristor, etc. The at least one contact element is thereby arranged in the female terminal and serves as terminal clamp for a plug-in contact of the component. In one variation, the electrotechnical component part can additionally have at least one slot for an electromagnetic switch, e.g., a relay or a contactor. The female terminal can be designed for the mounting on the mounting rail in rows.

The present description demonstrates the principles of the disclosure according to the invention. It thus goes without saying that experts will be able to design different assembles, which are not explicitly described here, but which embody principles of the disclosure according to the invention and the scope of which is to likewise be protected.

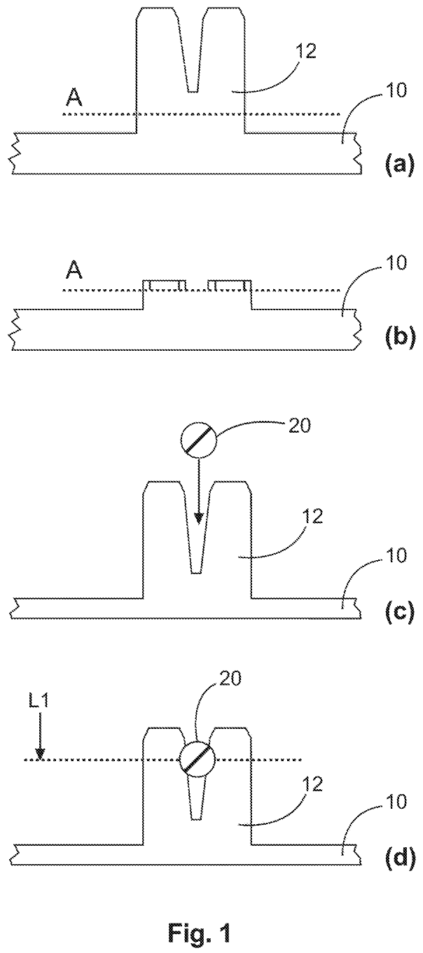

FIG. 1a shows a contact element of the type as it is currently already used in electrotechnical component parts to contact connecting wires. The connecting wires can also be connecting legs of electrotechnical component parts. An electrotechnical component is understood to be passive components, such as resistors, capacitors, and coils, relay and contactor, as well as active components, such as diodes, transistors, thyristors, etc., including integrated circuits.

So-called leadframes are used in electrotechnical component parts, in which only few such components are required in order to contact such components. These are specially formed contact elements, which consist of leadframe parts, which are then also specially bent and angled. Further processing steps would be drilled, riveted, etc. In FIG. 1a, reference numeral 10 identifies the leadframe part. It is punched from a metal band during the manufacture. A contact tab 12, which is notched in a V-shaped manner and a part of the connection line can be seen, in order to connect it to further elements of the electrical or electronic circuit of the electrotechnical component part. The leadframe part typically consists of metal. There are metals, which are highly electrically conductive, such as silver, gold, copper, or aluminum. By means of an alloy, the desired properties with respect to electrical conductivity and flexibility, thermal behavior, etc., can be set. The leadframe part can generally also consist of non-metallic material. In FIG. 1a, the letter A identifies a line, along which a deformation can take place. The deformation is an angulation (or curvature). For example, an angulation by 90° can take place. It can be seen that these known deflections take place at a location of the contact tab 12, where there is no longer a recess in the contact tab 12. For production-related reasons, such angulations are typically performed by means of edging machines or bending machines. It is pointed out, however, that other terms can be used synonymously for the term curvature line (or bending line or angulation line). Examples are the terms bending line and edging line. It is important that a section of the contact tab is deflected or angled, respectively, or edged, respectively, along the line with respect to a further section of the contact tab in such a way that the sections are engaged at an angle to one another. Even though it is preferred, the angle does not have to be identical over the entire angulation region. A skewed angulation would also be possible as further variation. In the region of the recess, the angulation line thereby lies from the end on the side of the component part interior to the beginning on the outer free edge of the recess.

FIG. 1b shows the contact element 10 after angulation has taken place along the line A. The view corresponds to a top view, as in FIG. 1a.

FIG. 1c shows a side view of the contact element 10 formed in this way. It can be seen therein that the recess of the contact tab 12 was completely angled. Due to the V-shaped recess, a cutting-spring region is created, into which a connecting wire 20 can be pressed. The connecting wire 20 will very often be a small connecting leg of an electrotechnical component.

FIG. 1d shows the same view of the contact element 10 with pressed-in connecting wire 20. It is even desired thereby that the connecting wire is slightly cut by means of the press-in. It is then held especially firmly and cannot shift in the longitudinal direction. Shocks could otherwise lead to a shifting of the wire and finally to the release of the contacting.

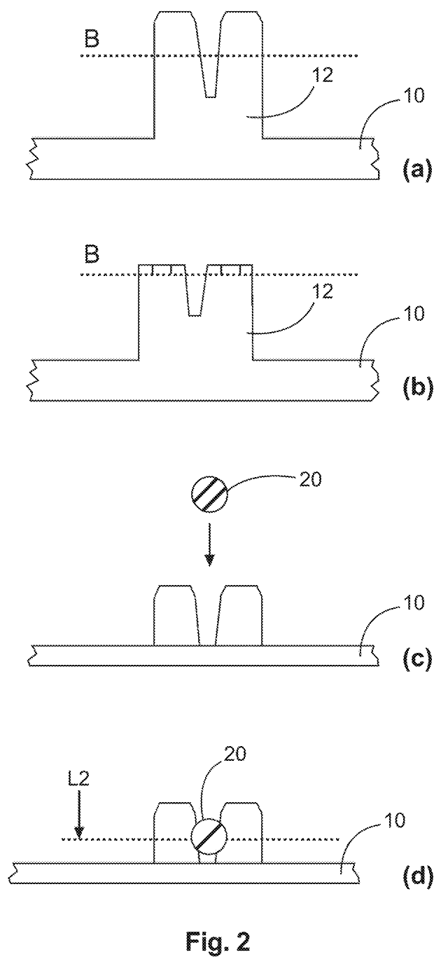

FIG. 2 shows a special construction of a contact element 10, which is designed for a particularly narrow construction. On principle, the contact element is constructed identically as in the case of the contact element illustrated in FIG. 1. The same reference numerals identify the same components as in FIG. 1. The contact tab 12 with V-shaped recess is likewise present. The connecting wire 20 is likewise pressed into the recess. It is important that in spite of narrow construction, a spring-loaded contact connection is likewise maintained. This is attained in that the angulation of the contact tab 12 is performed at a location, which is brought forward. The location, which is brought forward, is identified with the letter B in FIG. 2. This location is brought forward towards the open end of the contact tab 12. The angulation is thus performed at a location of the contact tab where the recess has not ended yet. FIG. 2a shows the angulation location B at the contact tab before the angulation process.

In FIG. 2b, the contact element 10 is shown after the angulation process. In the case of this view, the bent-over part of the contact tab 12 protrudes outwards to the front. The angulation reaches an angle of 90°.

FIG. 2c shows a side view of the angled contact element 10. The ratios are such that in spite of the small length of the angled part of the contact tab 12, the connecting wire 12 can still be pressed into the recess.

Lastly, FIG. 2d shows the same side view with inserted connecting wire 20.

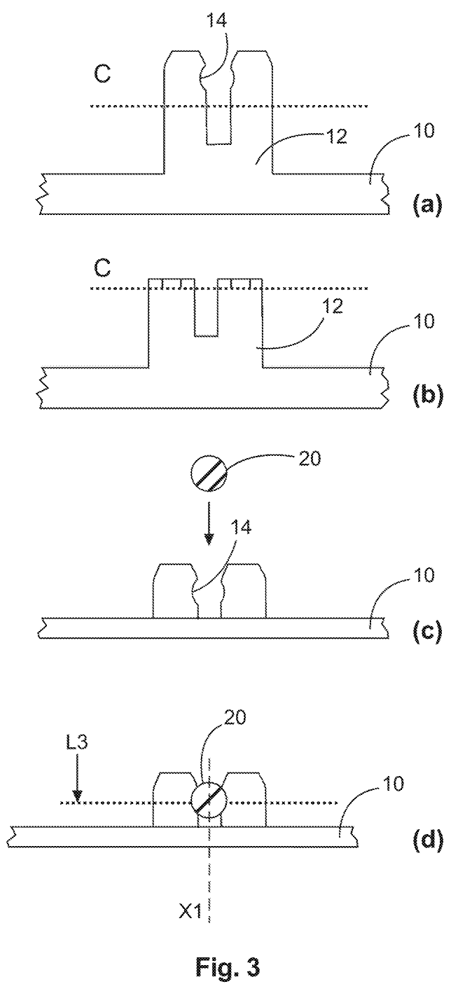

Another embodiment is illustrated in FIG. 3. FIG. 3a shows that the cutting region is equipped with a snap-in point 14, into which the connecting wire 20 can glide. In the case of this variation, the recess is designed in the shape of a rectangle. The glide-in region can also be designed in the shape of a V thereby, as shown in FIG. 1. To reach the end position, however, both legs of the contact tab 12 have to initially be pushed to the outside in the first step by means of the connecting wire. Due to the locking in the snap-in point 14, the connecting wire 20 can be held better against mechanical environmental influences. FIG. 3b shows the top view onto the contact element 10 after deflection has taken place. FIG. 3c shows the corresponding side view, and FIG. 3d shows the side view when the connecting wire 20 is pressed in.

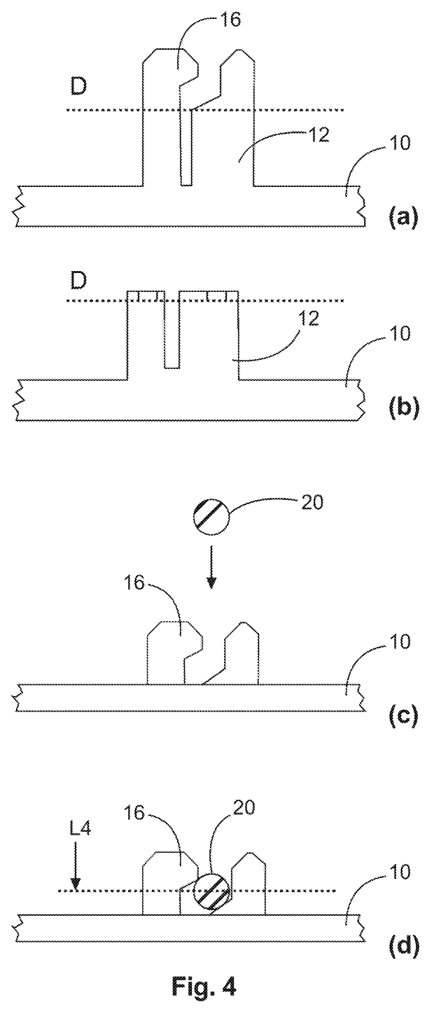

Another option for the realization is shown in FIG. 4. The recess in the contact tab 12 is specially formed. In one part, the recess has the shape of an elongated rectangle. In another part, the recess is wider, but runs obliquely. After the opened side, a section that runs straight adjoins the oblique region of the right leg of the contact tab 12. In the case of the left leg of the contact tab 12, a configuration that protrudes into the recess adjoins the continuous straight section created by the rectangular recess at the open end. This configuration preferably has a convex shape, so that it protrudes into the recess. A barbed hook 16 is thus created, which holds the inserted connecting wire 20 at its position. The construction thereby provides that when the connecting wire 20 is pressed into the recess, both legs are pushed to the outside. The end position of the connecting wire 20 is reached when the connecting wire 20 abuts on the stop bevel of the right leg, and the barbed hook 16 has sprung back freely again. The barbed hook 16 ensures a firm hold in response to electrical and mechanical stress. The further FIGS. 4b to 4d show the various views of this construction as in the case of FIGS. 1 to 3. FIG. 4d shows the position, at which the pressed-in connecting wire 20 is held by means of the barbed hook 16, which sprung back.

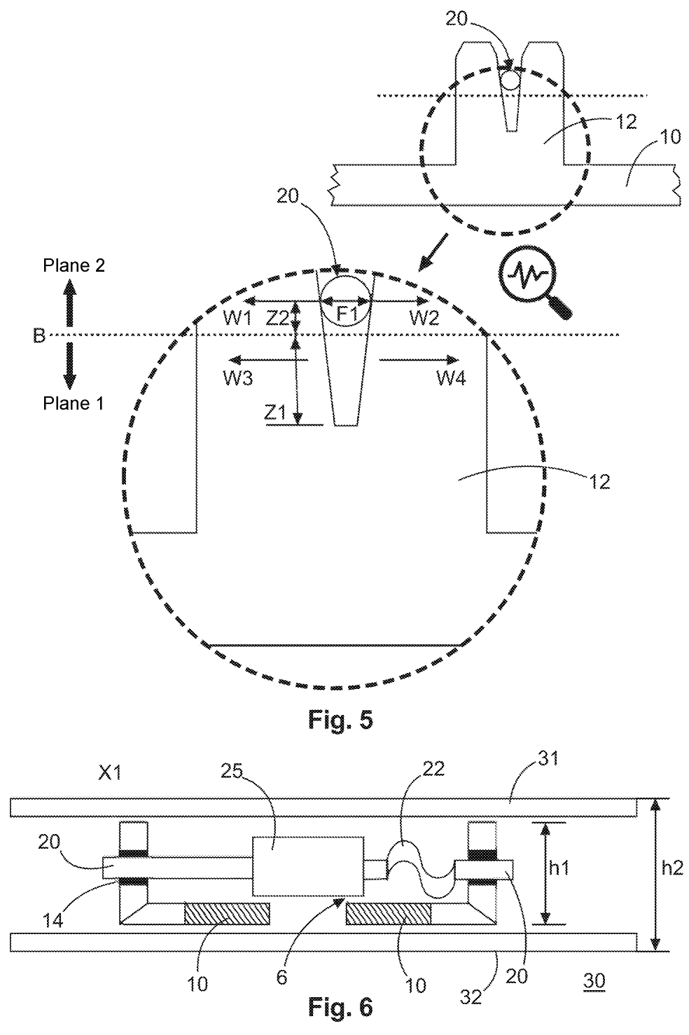

The details of the special angulation are illustrated in more detail in FIG. 5. It can be seen that after angulation, the recess extends over two different planes. The connecting wire is pressed into plane 2. For differentiating purposes, the plane 1 is also referred to as leadframe plane, and the plane 2 as cutting region. The solution according to the invention for attaining a particularly flat construction for contacting a wire component can be attained in such a way that the contact tab is divided by deformation into different resilient partial regions, which lie in different planes.

In the case of the known construction, cutting and spring region were in one plane 2. In the case of the new construction, the spring region extends over two planes. In plane 2, a suspension in the directions W1 + W2 takes place. In addition, the plane 1 is used for a particularly flat construction in order to obtain a further spring region in the directions W3 + W4. After the pressing process, the plane 1 is at a right angle to the plane 2 and thus lies below the wire component.

Due to the length of the lever Z1 in the plane 1 and Z2 in the plane 2, the counter force (F2) (spring tension) can be set to the weight force of the component part, which hangs on the connecting wire 20, by means of (F1). As a result, the angulation position of A and B, C, and D, and thus the distance L1 can be reduced to the dimension L2, L3, L4 with this measure.

FIG. 6 shows a section X1 through a female terminal, in which the specially formed contact elements 10 for contacting a component 25 are installed. The female terminal 30 is embodied in particularly narrow construction. The slot for the female terminal has a width, which is specified by the distance h1. This distance can be a few millimeters, e.g. 3 mm. The electrotechnical component 25 can be plugged into a slot of the female terminal 30. The housing sides of the female terminal are identified with reference numerals 31, 32. The contact elements for contacting the small connecting legs of the component 25 are again identified with reference numeral 10. In the case of the connecting wire 20, a bead 22 is impressed. This serves the purpose of length compensation during mechanical stress on the component 25. A further bead can also be impressed on the connecting wire 20 on the left side of the component 25. The component 25 can be provided with further connecting wires 20, which can be arranged in an offset manner. The shown component relates to a resistor. Other examples of components relate to diodes, capacitors, transistors, thyristors, etc.. A slot constructed in a similar way can also be used to contact a mini relay, e.g. a mini relay with a construction width of 3 mm. In the case of this alternative, a correspondingly constructed mini relay is plugged into a slot, which has the contact elements 10 according to the invention. The small connecting legs of the mini relay are then also contacted via the contact elements according to the invention.

It should be understood that the proposed method and the corresponding devices can be implemented in different forms of hardware, software, firmware, special processors, or a combination thereof.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of Reference Numerals

| | |
|---|---|
| Contact element | 10 |
| Contact tab | 12 |
| Snap-in point | 14 |
| Barbed hook | 16 |
| Connecting wire | 20 |
| Bead | 22 |
| Component | 25 |
| Female terminal | 30 |
| Upper housing wall | 31 |
| Lower housing wall | 32 |
| First curvature (or bending) line | A |
| Second curvature (or bending) line | B |
| Third curvature (or bending) line | C |
| Fourth curvature (or bending) line | D |
| First distance of wire to the leadframe | L1 |
| Second distance of wire to the leadframe | L2 |
| Third distance of wire to the leadframe | L3 |
| Fourth distance of wire to the leadframe | L4 |
| Leg length plane 1 | Z1 |
| Leg length plane 2 to the wire | Z2 |
| Spring direction plane 2 | W1 |
| Spring direction plane 2 | W2 |
| Spring direction plane 1 | W3 |
| Spring direction plane 1 | W4 |

1. A contact element for contacting electrotechnical components, comprising:
a leadframe part comprising an electrically conductive material, having a recess in a contact tab,
wherein the contact tab is formed to be curved at at least one location such that a curving line, along which a curvature is present, extends between a beginning and an end of the recess and runs transversely through the contact tab in a straight line.

2. The contact element of claim 1, wherein the recess is formed, starting at an outer, free edge of the contact tab, in a direction of an opposite edge of the contact element.

3. The contact element of claim 2, wherein the recess comprises a motion guide, which extends along a line between a beginning and an end, the line being curved or angled at least in some sections.

4. The contact element of claim 2, wherein the recess is formed so as to taper in a shape of a V.

5. The contact element of claim 2, wherein the recess is formed in a slit-shaped manner with parallel lateral lines, and
wherein the recess in an angled upper part of the contact tab is formed such that at one location the recess has a snap-in point.

6. The contact element of claim 2, wherein the recess extends along a straight, curved, or angled line on one side of the-an upper end, and, on an other side of the upper end, ends in a configuration, which protrudes into the recess, and which serves as a barbed hook for the a connecting wire of the electrotechnical component pushed into the recess and so as to counter a fall-out of the pushed-in connecting wire.

7. The contact element of 6, wherein the configuration protruding into the recess on the other side of the upper end bulges convexly into the recess.

8. An electrotechnical component part, comprising:
at least one contact element of claim 1.

9. The electrotechnical component part of claim 8, wherein the electrotechnical component part is configured as a female terminal for a mounting rail assembly, and which has at least one slot for the electrotechnical component, and
wherein the at least one contact element is arranged in the female terminal and serves as a terminal clamp for a plug-in contact of the electrotechnical component.

10. The electrotechnical component part of claim 9, wherein the female terminal further comprises a slot for an electromagnetic switch comprising a relay or contactor.
